(19) United States
(12) Patent Application Publication
(10) Pub. No.: US 2004/0091076 A1
(43) Pub. Date: May 13, 2004

(54) Method and system for nondestructive inspection of components

(75) Inventors: Daniel S. Kerr, Clayton, CA (US); Ronald B. Alers, San Luis Obispo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Pacific Gas & Electric Company, San Francisco, CA

(21) Appl. No.: 10/291,212

(22) Filed: Nov. 8, 2002

(51) Int. Cl. G21C 19/00

(52) U.S. Cl. 376/260

(57) ABSTRACT

A method and system utilizing polarized ultrasonic shear waves and other guided waves to detect and characterize flaws oriented parallel to the wave propagation direction and perpendicular to the wave particle motion. As the wave passes, the waves are dampened by these flaws causing a reduction in the received signal amplitude as well as other changes in the signal. This inspection can be applied to nuclear reactor vessel control rod drive mechanisms (CRDMs) and other tubular and plate products. In addition, the same waves are utilized to detect and characterize other types of flaws in CRDMs.

### BACKGROUND OF THE INVENTION

The present invention relates generally to the field of nondestructive evaluation (NDE) and more specifically to a system and method of examining materials for defects without appreciable damage to the tested materials.

Such material defects can be found in control rod drive mechanisms (CRDMs) employed in nuclear reactors, for example. The nuclear industry has recently observed material defects in some of its nuclear reactor CRDM tubes. The CRDM is used to moderate nuclear reaction in a nuclear power reactor. After years of operation, CRDM tubes in some reactors have experienced cracking due to the tube material, high temperatures, mechanical stresses, and the environment in and around the tube. For example, controlled nuclear reactions can result in extremely high temperatures and pressure. Temperatures as high as 600° F. are not uncommon. The reactor vessel and a CRDM will now be briefly described to illustrate occurrence of various types of material defects.

FIG. 1A illustrates one type of a nuclear reactor vessel 100 having a plurality of CRDM 102 in a tophead 110.

Among other components, nuclear reactor vessel 100 includes a shell 114, which contains the fuel for generating heat by nuclear fission. Nuclear reactor vessel 100 further includes the tophead 110 for covering reactor shell 114. Tophead 110 is detachably coupled to reactor base 114 via flange studs 112. The head can be removed to refuel the reactor and perform other maintenance inside the reactor.

A plurality of CRDMs 102 extend through holes in the tophead 108, as shown in FIGS. 1A and 1B. A CRDM is used to raise and lower neutron absorbing control rods 104 into a fuel bundle area 119 to increase and decrease the nuclear reaction and resultant heat produced. Each CRDM 102 comprises a tubular housing 106 which is interference fitted through a detent hole 108 and welded in-place 118 to firmly hold the CRDM in place, as shown in FIG. 1B. Moreover, the full penetration weld further functions as a water pressure seal for retaining water within the nuclear vessel 100.

The problem is that recently, various defect types have been appearing in the CRDM housing tubes 106 and the full penetration welds 118. These defect types include axial cracks 116 primarily within +/−45° of the tube axis, circumferential cracks 122 primarily within +/−45° of being perpendicular to the tube axis, and weld cracks 120 in the weld 118 adjacent to the tube. Circumferential cracks 122 can initiate on the outside surface of the tube in the interference fit area and propagate toward the inside of the tube. When severe, circumferential cracks can extend entirely around the CRDM periphery. Consequently, the high reactor pressure and temperature can result in ejection of the CRDM from the tophead. Ejection of the CRDM from the tophead can cause a loss of coolant accident, unanticipated outages costing millions of dollars, and high levels of radiation contamination in the containment building.

Although conventional inspection systems and methods for detecting cracks in CRDMs exist, such systems and methods have several drawbacks. One method is to perform visual or video inspections to locate residual boric acid on the outside of the tophead which has seeped through the defects. However, these visual inspections will only see the indirect evidence of a “through-wall” leak if enough residual boric acid is deposited on the surface accessible to the visual inspection. In addition, it will not see defects which are either hidden from view or are too tight to detect. These CRDM cracks are not directly visible by visual methods in most cases.

Another type of conventional method involves the use of piezo-electric ultrasonic and/or eddy current sensors. Such transducers are typically employed during an outage to access the interior of the CRDM housing tube. During the outage, tophead 110 is removed and placed on a stand. Thereafter, sensors attached to robots are run through interior 124 of CRDM 102 from under the head. The sensors can then proceed back and forth within the CRDM interior to interrogate the tube surface and volume for defects. This method, however, is relatively expensive and slow. Further, as noted, this method can be performed only during specific outage periods when the CRDM interior is accessible and is performed in a very high radiation environment.

### BRIEF SUMMARY OF THE INVENTION

A method and system is disclosed for nondestructive inspection for flaws in tubular and plate-type components and associated welds, as well as turbine blade roots and the blade mounting area on a turbine disk. Such material defects may include axial and circumferential crack-like defects. In an exemplary embodiment, the present invention is used to inspect a control rod drive mechanism (CRDM) tubular housing for material defects.

A CRDM is located in the tophead of some designs of a nuclear reactor vessel for the purpose of advancing or retracting control rods into the nuclear reactor vessel. The control rods are used to absorb neutrons in order to moderate the nuclear fission reactivity. The method of the present embodiment begins when a transducer is mounted on the upper uncovered portion of the CRDM. By way of example, this transducer can be mounted using a scanner. The transducer, which includes a transmitter and a receiver, is mounted to an external portion of the CRDM tube housing, such as above the tophead insulation on a pressurized water reactor. By mounting the scanner in this location, the entire inspection can be performed quickly and in a much lower radiation area since no access is required to the inside of the tube from the underside of the tophead.

Typically, scanning is performed in the circumferential direction around the tube, perpendicular to the direction of propagation of the ultrasonic waves along the axis of the tube. In one embodiment, the scanning is performed by mechanically moving the transducers. In another embodiment the scanning is performed by first encircling the entire circumference with a set of transducers, then electronically sequencing them around the circumference to collect ultrasonic data without moving them. In either case, the transducers transmit and receive shear horizontal (SH) and other guided ultrasonic waves propagated in the direction of the tube axis. When using SH waves in this application, the propagation direction is axial, and the particle motion is parallel to the surface of the tube in the circumferential direction.

Next, the acoustic signals received by the transducer are analyzed on the ultrasonic inspection equipment. When no defects are present, a consistent reference reflection from the far end of the tube is observed. However, when a defect is detected in the tube or adjacent weld, in one embodiment the reference reflection off the far end of the tube will be reduced in amplitude and/or appear at a different transit time. When SH waves are used, defects parallel to the beam propagation direction and perpendicular to the particle motion direction, are detected. In another embodiment, a defect is detected by observing an additional reflection at an earlier transit time than the reference reflection from the far end of the tube. Many defects will manifest themselves by exhibiting both of these embodiments. Mode conversions or diffraction of the ultrasonic wave may also occur due to the interaction with a defect. In this case, additional signals may also appear at other locations along the time base at different transit times than expected.

### BRIEF DESCRIPTION OF THE DRAWINGS

FIG. 1A illustrates a nuclear reactor vessel having a plurality of control rod drive mechanisms.

FIG. 1B illustrates a single control rod drive mechanism (CRDM) in a tophead.

FIG. 2A illustrates an exemplary system for detecting material defects in the CRDM according to an embodiment of the present invention.

FIG. 2B illustrates an alternate system according to an embodiment of the present invention.

FIG. 3A is an exemplary representation of a data display for a material with no defects according to an embodiment of the present invention.

FIG. 3B is an exemplary representation of a data display for a material with a circumferential material defect according to an embodiment of the present invention.

FIG. 3C is an exemplary representation of a data display for a material having an axial material defect in accordance with an embodiment of the present invention.

FIG. 4 is an exemplary representation of various types of transducer configurations which may be utilized in the present invention.

A further understanding of the nature and advantages of the present invention herein may be realized by reference to the remaining portions of the specification and the attached drawings. References to “steps” of the present invention should not be construed as limited to “step plus function” means, and are not intended to refer to a specific order for implementing the invention. Further features and advantages of the present invention, as well as the structure and operation of various embodiments of the present invention, are described in detail below with respect to the accompanying drawings. In the drawings, the same reference numbers indicate identical or functionally similar elements.

### DETAILED DESCRIPTION OF THE INVENTION

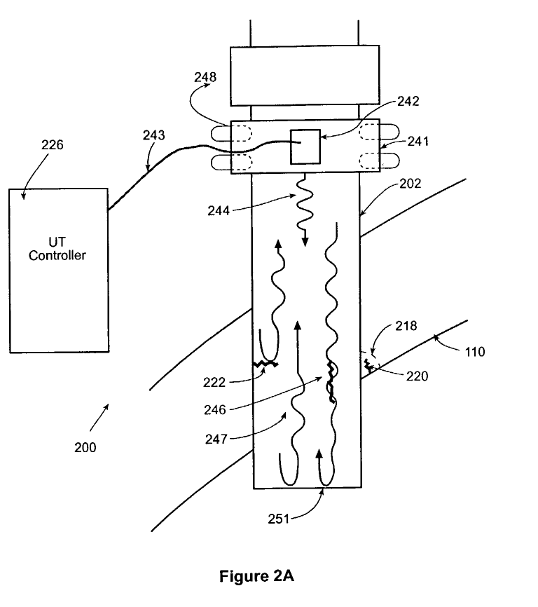

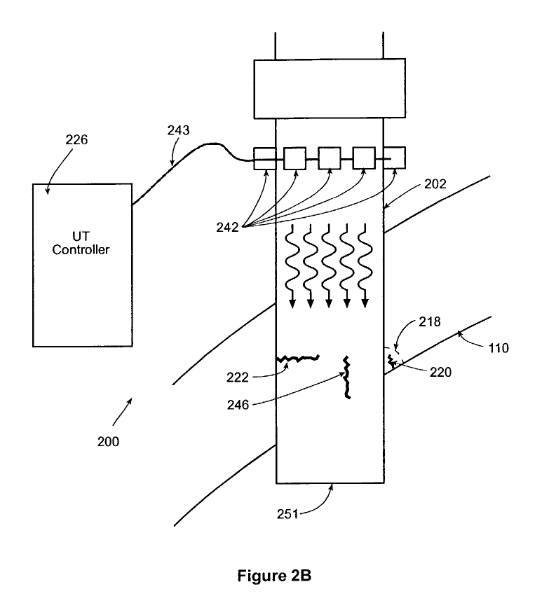

FIG. 2A illustrates an exemplary system 200 for detecting material defects in a control rod drive mechanism (CRDM) 200 according to an embodiment of the present invention.

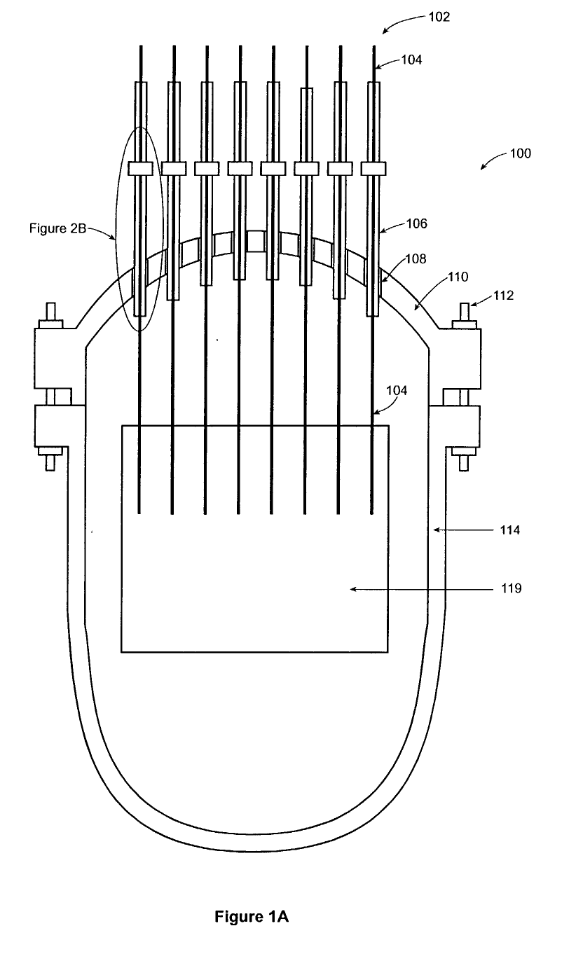

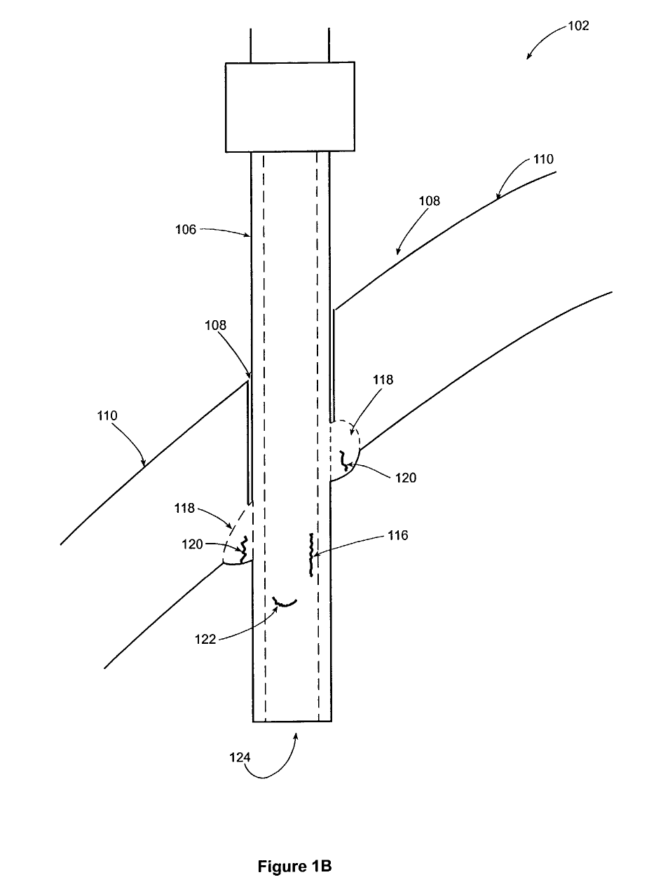

Among other components, system 200 comprises one or more transducers 242 for generating one or more modes of ultrasonic waves 244 and for receiving associated waves 247 after interaction with the reference backwall 251 and/or defects such as a circumferential defect 222, axial defect 246, or as illustrated in FIG. 1B, a weld defect 120. System 200 further comprises ultrasonic inspection equipment, or controller 226, for operation of the system. Ultrasonic inspection equipment 226 includes a pulser, a receiver, synchronizing clocks, display, input/output, processing, memory, motion control, etc. Ultrasonic inspection equipment 226 is coupled to transducer 242 via a communication link 243. Communication link 243 may be a cable (e.g.—coaxial) or wireless link as appropriate.

A user wishing to employ system 200 to detect one or more types of defects begins by mounting transducer 242 on CRDM 202, as shown. Transducer 242 can be a non-contact ultrasonic transducer although other transducer types can be employed. One suitable transducer, for example, is an electromagnetic acoustic transducer (EMAT) well known to those of ordinary skill in the art. An EMAT is a wire loop (not shown) held adjacent to a magnet(s) and electromagnetically excited in such a way as to induce ultrasonic waves of the desired mode(s) in an electrically conductive material.

Depending on the EMAT, it may have a single integrated transmitter and receiver, or a separate transmitter and receiver. The transmitter/receiver loops are available in many different shapes and sizes and are quite versatile for generating and detecting different modes of ultrasonic waves. Alternating current in the transmitter loop combined with induced eddy currents cause ultrasonic waves to be transmitted through a material to which the EMAT is attached. Received signals are transduced through the inverse of this process.

After transducer 242 is mounted on CRDM 202, a pulser (not shown) in the ultrasonic inspection equipment is used to power the transducer to generate the ultrasonic signals (e.g., signal 244) through CRDM tube 202, as previously discussed. EMAT pulser circuits are typically high power applying a few hundred amperes of transmitter current to the EMAT transducer to generate the ultrasonic signals. The transmitted ultrasonic signal 244 is reflected off the CRDM tube backwall 251. In FIGS. 2A and 2B, the reflected signal 247 is shown. Thereafter, reflected signal 247 is sensed by transducer 242, and converted back to an electrical signal for forwarding to ultrasonic inspection equipment 226. In turn, ultrasonic inspection equipment 226 displays the received signals which indicate the absence or presence of defects and other associated characteristics of the material being tested.

The transmit/receive procedure is performed around the entire circumference of housing 106. Alternatively, for a non-cylindrical material, the transducer can be traversed in a direction perpendicular to the propagation direction of the acoustic wave.

Other embodiments can traverse in different directions and can even use static placement of one or more transducers. In general, any type of transducer placement and motion can be used. Traversal need not be a complete loop but can be any segment of movement.

Referring to FIG. 2A, the user employs a scanner 241 to slowly traverse transducer 242 circumferentially around tube housing 106 during the data acquisition process. The scanner 241 can be adapted to traverse transducer 242 either in a clockwise or counter-clockwise direction 248 as shown. By slowly scanning around the tube circumference, reflected waves are transmitted and received by transducer 242 at numerous circumferential positions. Ultrasonic signals travel much faster than transducer traverse speeds and, thus, the transducer can send receive ultrasonic signals for each position before proceeding to the next position.

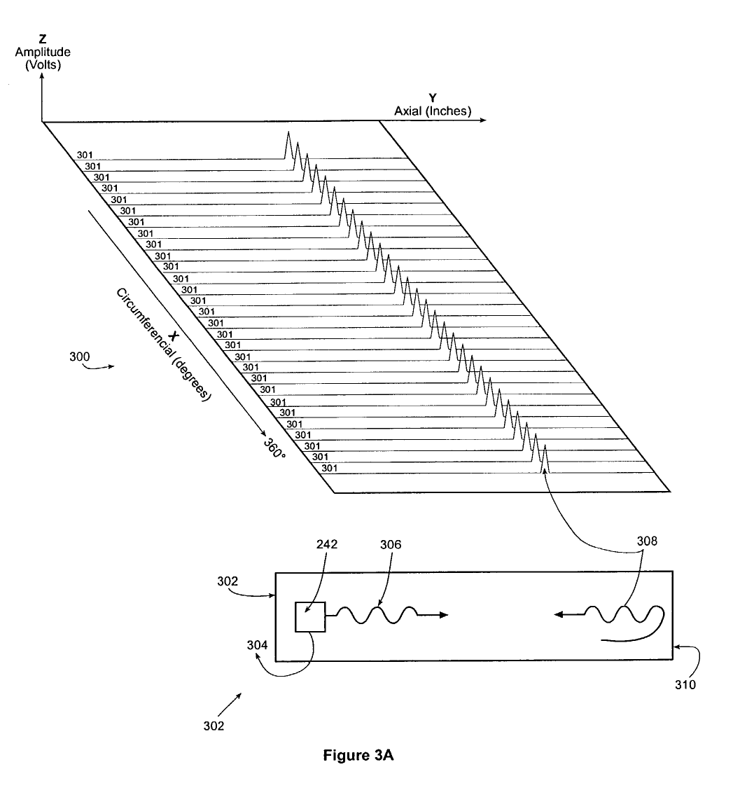

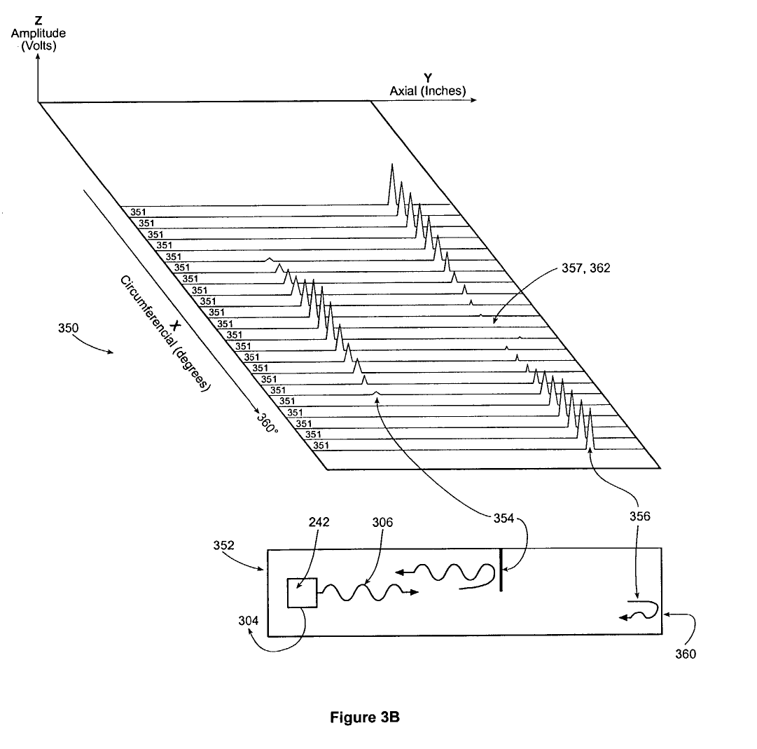

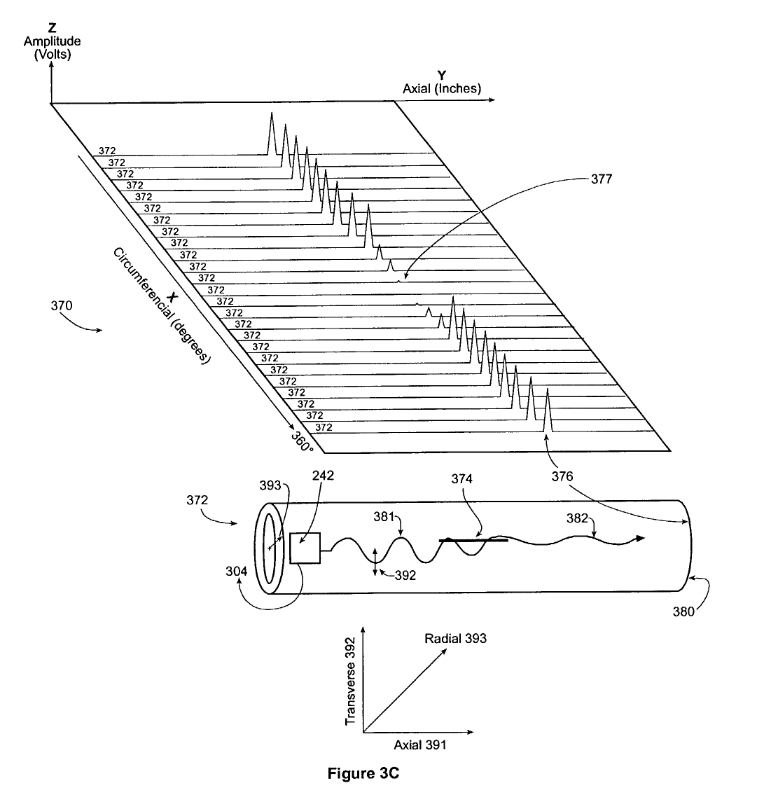

The need to traverse CRDM 202 can be avoided by using the alternate embodiment shown in FIG. 2B. In FIG. 2B, a plurality of stationary transducers 242 are mounted around the periphery of CRDM 202. Each transducer can be a transmitter and/or receiver for transmitting and receiving signals for a designated circumferential position. Thus, this embodiment eliminates use of the scanner 241 during data acquisition since multiple stationary transducers can be sequenced around the entire circumference. In one embodiment shown FIG. 3A, the tested material is a simulated CRDM tube made of carbon steel material 302 having a half inch wall thickness and a four inch outside diameter.

Carbon steel was used to simulate the actual CRDM material, Inconel®, since for this case it was ultrasonically similar to Inconel. An actual Inconel® CRDM tube was used to confirm the ultrasonic similarity. The desired shear-horizontal (SH) or other guided wave mode/order is selected based on the ultrasonic properties and the wall thickness of the material being inspected. This is easily determined by one of ordinary skill in the use of guided ultrasonic waves for NDE. For this embodiment, an SHO (SH “zero”) mode/order was utilized primarily.

FIG. 3A shows a series of typical ultrasonic transit time vs. amplitude signals 301 (i.e.—A-scans) stacked together in a “waterfall” display 300 representing in this case an exemplary inspection of a simulated CRDM tube with no defects, in accordance with an embodiment of the present invention.

Accordingly, in FIGS. 3A-3B-3C, the Y-axis is the material length in inches, or the distance between transducer 242 and the location where the signal is reflected since distance is directly proportional to transit time when the ultrasonic velocity of a given wave mode is known for the inspected material. Therefore, the Y-axis represents the transit time or distance for the reflected signals to travel from the transmitter transducer 242 to the reflection location and back to receiver transducer 242. In this case, the transmitter and receiver transducer are the same, but in other examples they may be separate transducers. The X-axis is the material circumference in degrees. The Z-axis is signal amplitude.

The display in FIG. 3A shows a relatively constant and smooth region 308 representing the backwall and indicating the absence of defects in a material 302. In the material, the path of the waves 306 between the transmitter/receiver 242 and the backwall 310 was not blocked or interfered with by defects. Accordingly, region 308 of display 300 is consistent and smooth from 0° through 360° around material 302 circumference 304. This region 308 will be contrasted to region 356 of FIG. 3B, and region 376 of FIG. 3C as further described below.

FIG. 3B shows a series of typical ultrasonic transit time vs. amplitude A-scans 351 stacked together in a “waterfall” display 350 representing in this case an exemplary inspection of a simulated CRDM tube with circumferential defects, in accordance with an embodiment of the present invention.

In this case, the tube 352 includes a circumferential material defect (notch) 354, as shown. FIG. 3B shows that the display 350 now has several changes from the case of no defects represented in FIG. 3A. The backwall region 356 of the display has an uneven or discontinuous portion 357. This uneven or discontinuous portion indicates that a defect, in this case, circumferential flaw 354, has blocked and otherwise interfered with the wave path. A fluctuation region can include one or more uneven or discontinuous portions or other signal or waveform characteristics that vary relative to other unflawed portions. For example, the waveform amplitude can drop in region 357 relative to other portions of region 356.

In this manner, the presence of circumferential flaw 354 can be detected and characterized by the present invention based on the presence of shadow 362, as represented by the uneven or discontinuous region 357. Circumferential flaw 354 can also be detected and characterized by the presence of region 354 on the display 350. This region is caused by direct reflection of transmitted waves from circumferential flaw 354. Region 354 on the display is interpreted as being earlier in transit time, or shorter distance from the transducer, relative to the backwall region 356. However, due to beam-spread, mode-conversion, and diffraction of the ultrasonic wave, there may also be signals from the flaw which show up at other transit times.

In addition, the display can be used to determine the axial and circumferential location and size of circumferential flaw 354. The length of carbon steel tube 350 is known, the velocity of the ultrasonic signals are known, thus, the axial location of the circumferential flaw 354 is easily determined from said region. The transducer orientation and circumferential location are known, thus, the circumferential location and length of the defect can be determined. The ratio of transmitted vs. reflected energy from the defect and backwall provides the radial depth of the defect when used with other information provided by the system.

FIG. 3C shows a series of typical ultrasonic transit time vs. amplitude A-scans stacked together in a “waterfall” display representing in this case an exemplary inspection of a simulated CRDM tube with axial defects, in accordance with an embodiment of the present invention.

In this case, the tube 372 includes an axial material defect (notch) 374, as shown. FIG. 3C shows that the display 370 now has several changes from the case of no defects represented in FIG. 3A or the circumferential defect in FIG. 3B. The backwall 380 region 376 of the display has an uneven or discontinuous portion 377 without a corresponding reflected signal 354 seen in FIG. 3B before the backwall. This uneven or discontinuous portion indicates that a defect, in this case, axial flaw 374, has interfered with the wave, as explained below. A fluctuation region can include one or more uneven or discontinuous portions or other signal or waveform characteristics that vary relative to other unflawed portions. For example, the waveform amplitude can dropout in region 377 relative to other portions of region 376.

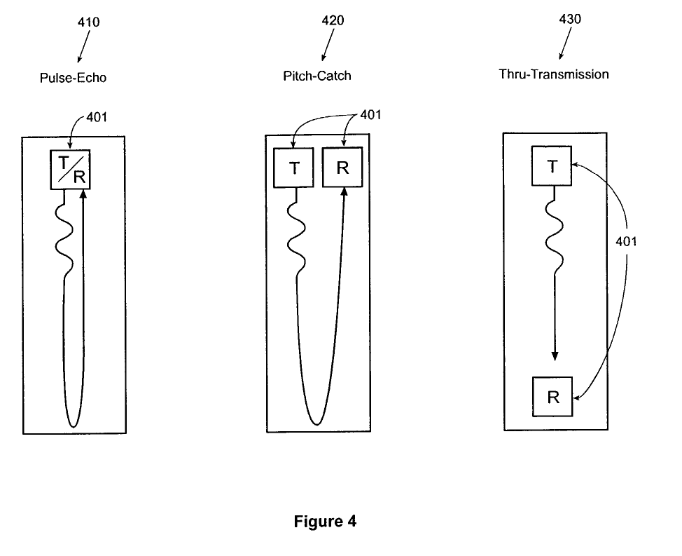

In FIG. 3C, a shear horizontal (SH) wave with a certain amplitude 381 propagating in the axial direction 391 with particle motion in the transverse direction 392, will have a reduction in amplitude 382 when it passes a flaw 374 oriented in a predominately radial 393-axial 391 plane. This can be observed using various types of the transducer 401 transmitter-receiver configurations shown in FIG. 4, (e.g.—pulse-echo 410, pitch-catch 420, or through-transmission 430), as desired for any component being inspected, not just CRDMs.

In this manner, the presence of axial flaw 374 can be detected and located circumferentially and depth sized radially by the present invention based on the presence of uneven or discontinuous region 377 and the characteristics of the signals in that region. With some axial flaws, a small direct reflection signal from the flaw can also be observed and this will provide axial location information.

Another embodiment using this dampened polarized shear wave method (although not shown) is the detection of laminar flaws parallel to the surface in pipe or plate material when the transducers are placed on the edge of the material. When a shear vertical (SV) wave, propagating parallel to the surface of the material with particle motion perpendicular to the surface, encounters a laminar flaw perpendicular to the particle motion, it will dampen the wave and this will be observed on the ultrasonic display unit.

Although not shown, this procedure for axial flaws can also be applied to flaws in adjacent welds attached to the tube or plate being inspected. These flaws in adjacent welds may not be observed on the display as a direct reflection, but the change caused by the presence of an anomaly in the adjacent weld as the ultrasonic wave passes will manifest itself by a change in the backwall reference reflection.

Yet another embodiment using this dampened polarized shear wave method is the detection of flaws in the roots of turbine blades and the complementary blade-fit areas in turbine disks on axially-mounted turbine blade design rotors. When the transducers are placed on the outer flat faces of these areas and SH waves are propagated through the areas in the axial direction, the presence of root cracks is observed by noting a fluctuation or discontinuous portion of the scan, or other signal or waveform characteristics that vary relative to other unflawed portions.

This present invention utilizes various interactions of the ultrasonic wave with defects and other discontinuities to detect, locate, and characterize the defects. This includes electronic and geometry references, signals from reflectors, diffraction signals as the wave passes defects, mode-converted signals, beam-spread effects, multiple paths of the wave, signal amplitude, and dampening or attenuation caused by a flaw in the wave-path when that flaw is perpendicular to the particle motion and parallel to the wave propagation direction of a polarized shear wave.

Referring to FIG. 4, the transducers can be configured to provide pulse-echo 410, pitch-catch 420, or through-transmission 430 interrogation of the material under inspection, or any combination, utilizing one or more transducers.

In this fashion, the present invention provides a method and system for detecting, characterizing, locating, and sizing material defects in plates and tubular components such as CRDMs, as well as turbine blade roots and the complementary blade-fit areas on the turbine disks. While the above is a complete description of exemplary specific embodiments of the invention, additional embodiments are also possible. Thus, the above description should not be taken as limiting the scope of the invention, which is defined by the appended claims along with their full scope of equivalents.

What is claimed is:

1. A method of nondestructively inspecting control rod drive mechanisms for flaws, the method comprising:
providing a control rod drive mechanism;
generating one or more guided waves along an axial length of the control rod drive mechanism;
receiving the guided waves after they are propagated past a flaw or from said flaw on the control rod drive mechanism; and
processing the received guided waves to detect the flaw.

2. The method of claim 1 further comprising
using at least one electromagnetic acoustic transducer to generate the guided waves.

3. The method of claim 1 further comprising
using at least one piezo-electric transducer to generate the guided waves.

4. The method of claim 1 wherein the guided waves are polarized shear waves.

5. The method of claim 1 wherein the guided waves are Lamb waves.

6. The method of claim 1 wherein the flaw is selected from the group comprising an axial flaw, a circumferential flaw and a weld flaw.

7. The method of claim 1 further comprising
using a scanner to mount a transducer on the control rod drive mechanism, wherein the transducer is used to generate and receive said guided waves.

8. The method of claim 1 wherein the step of processing the received guided waves further comprises displaying the received guided waves, wherein if a region of the displayed guided waves is relatively uneven or discontinuous, that region indicates the presence of a flaw in the control rod drive mechanism.

9. The method of claim 1 wherein the step of processing the received guided waves further comprises
displaying the received guided waves, such that, relative to a reference signal, if an additional signal is located closer or further away from a transducer that generates the guided wave, the presence of a flaw is indicated.

10. A method of nondestructively inspecting tubular and plate components for flaws, the method comprising:
providing a tubular or plate component for inspection;
generating one or more guided waves in the component;
receiving the guided waves after they are propagated either past or from a flaw on the component,
wherein the flaw is substantially parallel to a propagation direction of the guided waves, and wherein the flaw is substantially perpendicular to a particle motion direction of the guided waves; and
processing the received guided waves to detect the flaw.

11. The method of claim 10 further comprising
using at least one electromagnetic acoustic transducer to generate the guided waves.

12. The method of claim 10 further comprising
using at least one piezo-electric transducer to generate the guided waves.

13. The method of claim 10 wherein the guided waves are polarized shear waves.

14. The method of claim 10 wherein the guided waves are Lamb waves.

15. The method of claim 10 further comprising
using a scanner to mount a transducer on the component, wherein the transducer is used to generate and receive said guided waves.

16. The method of claim 10 wherein the step of processing the received guided waves further comprises
displaying the received guided waves, wherein if a region of the displayed guided waves is relatively uneven or discontinuous, that region indicates the presence of a flaw in the component.

17. The method of claim 10 wherein the step of processing the received signals further comprises
displaying the received guided waves, such that, relative to a reference signal, if an additional signal is located closer or further away from a transducer that generates the guided wave, the presence of a flaw is indicated.

18. A system of nondestructively inspecting for flaws in a control rod drive mechanism, the system comprising:
at least one transmitter for generating guided waves through an axial length of the control rod drive mechanism;
at least one receiver for receiving the guided waves after they are propagated either past or from one or more flaws on the control rod drive mechanism; and
a processor for processing said guided waves to detect said flaws.

19. The system of claim 18 wherein the transmitters and the receiver are mounted along a circumference of the control rod drive mechanism.

20. The system of claim 18 further comprising a scanner for mounting the transmitter and the receiver on the control rod drive mechanism.

21. A system for nondestructively inspecting tubular and plate components for flaws, the system comprising:
a transducer comprising a transmitter and a receiver,
wherein the transmitter generates one or more guided waves along a length of the component,
wherein the receiver receives the guided waves after they are propagated either past or from a flaw on the component,
wherein the flaw is substantially parallel to a propagation direction of the guided waves, and wherein the flaw is substantially perpendicular to a particle motion direction of the guided waves; and
a processor for processing the received guided waves to detect the flaw.

22. The system of claim 21 further comprising
a scanner for mounting the transducer on the component.

23. A system of detecting a flaw in a control rod drive mechanism, the system comprising:
means for generating guided waves through an axial length of the control rod drive mechanism;
means for receiving the guided waves reflected from a backwall of the control rod drive mechanism; and
means for displaying the reflected guided waves, such that if at least one ultrasonic signal is located closer to said means for generating than signals reflected from the backwall of the metallic material, the presence of a flaw is indicated.

24. The system of claim 23 wherein said means for generating includes one receiver and one transmitter.

25. A system of detecting a flaw in a control rod drive mechanism, the system comprising:
means for generating guided waves through an axial length of the control rod drive mechanism;
means for receiving the guided waves reflected from a backwall of the control rod drive mechanism; and
means for displaying the reflected guided waves, such that if at least one ultrasonic signal is located closer to said means for generating than signals reflected from the backwall of the metallic material, the presence of a flaw is indicated.

26. The system of claim 25 wherein said means for generating includes one receiver and one transmitter.

27. A system for nondestructively inspecting tubular and plate components for flaws, the system comprising:
(a) at least one transducer capable of transmitting and receiving guided waves;
(b) a scanner, coupled to the transducer, the scanner for traversing the transducer across a surface of the component, wherein the transducer is traversed as it transmits and receives guided waves across the component surface to detect a flaw; and
(c) a processor, coupled to the transducer, the processor for detecting irregularities in data produced by the guided waves when compared to reference data.

28. A system for nondestructively inspecting tubular and plate components for flaws, the system comprising:
(a) a transducer set, fixedly attached along an entire circumference of the component, wherein each transducer transmits and receives guided waves along the surface of the component, in order to detect said flaws; and
(b) a processor, coupled to the transducer set, wherein the processor detects irregularities in data produced by the guided waves when compared to reference data.
